(19) United States
(12) Patent Application Publication
(10) Pub. No.: US 2008/0096154 A1
(43) Pub. Date: Apr. 24, 2008

(54) Dental camera with enhanced features

(75) Inventor: Zvi Rakocz, Ramat Hasharon (IL)

Correspondence Address: ABELMAN, FRAYNE & SCHWAB, 666 THIRD AVENUE, 10TH FLOOR, NEW YORK, NY, 10017, US

(73) Assignee: Miras Mirror Imaging Solutions Ltd.

(21) Appl. No.: 11/520,405

(22) Filed: Sep. 12, 2006

(51) Int. Cl. A61C 3/00

(52) U.S. Cl. 433/29; 433/215

(57) ABSTRACT

An intraoral viewing device includes a handle having a distal end, and a mirror mount, connected to the distal end of the handle, for insertion into a mouth of a patient. An image sensor is contained in the handle and coupled to provide electronic images of the inside of the mouth. A flexible sheath fits over and covers the mirror mount and the handle. A mirror is configured to be fastened to the mirror mount over the sheath, with the sheath intervening between the mirror and the mirror mount, so as to provide optical images of the inside of the mouth.

### FIELD OF THE INVENTION

The present invention relates generally to dental equipment, and specifically to intraoral cameras.

### BACKGROUND OF THE INVENTION

U.S. Pat. No. 6,276,934, whose disclosure is incorporated herein by reference, describes an intraoral viewing device, including a handle and a mirror, fixed to a distal end of the handle, for insertion into the mouth of a patient. A first image of the inside of the mouth is viewed by reflection from a surface of the mirror. An image sensor inside the handle receives a second image of the inside of the mouth along a beam axis passing through a plane defined by the surface of the mirror, and generates an electronic image responsive thereto. This device is said to provide the dentist with the convenience of handling one instrument, which is in use at all times in operative procedures, rather than juggling between a mirror and a camera. The dentist may use the device to perform the functions for which conventional dental mirrors are used, including organ retraction in the oral cavity and direct and indirect viewing of the patient's mouth.

Other dental mirrors and cameras with a variety of ancillary features are known in the art. For example, some dental mirrors contain a tube or bore for directing compressed air toward the mirror surface in order to prevent fogging and reduce debris buildup. Dental mirrors of this sort are described, for instance, in U.S. Pat. Nos. 3,986,266, 4,279,594, and 5,449,290, whose disclosures are incorporated herein by reference.

### SUMMARY OF THE INVENTION

There is therefore provided, in accordance with an embodiment of the present invention, an intraoral viewing device, including:

a handle having a distal end;

a mirror mount, connected to the distal end of the handle, for insertion into a mouth of a patient;

an image sensor, contained in the handle and coupled to provide electronic images of the inside of the mouth;

a flexible sheath, which fits over and covers the mirror mount and the handle; and

a mirror, which is configured to be fastened to the mirror mount over the sheath, with the sheath intervening between the mirror and the mirror mount, so as to provide optical images of the inside of the mouth.

In some embodiments, the handle contains a lumen, which is configured to direct a pressurized fluid toward the mirror through a puncture in the sheath. Typically, the lumen has an outlet, and the device includes a plug, which is configured to puncture the sheath and to be received within the outlet of the lumen, the plug having a channel therethrough for conveying the pressurized fluid from the lumen to the mirror.

Additionally or alternatively, the device includes one or more electrical controls located on the handle, which are operable by a user of the device by applying pressure to the controls through the sheath.

In some embodiments, the device includes an optical assembly, which is configured to image the inside of the mouth onto the image sensor via an aperture in the device, and the sheath covers a transparent material, which covers the aperture. Typically, at least a part of the optical assembly is located in the mirror mount, and the aperture is located in the mirror.

There is also provided, in accordance with an embodiment of the present invention, an intraoral viewing device, including:

a handle;

an image sensor, contained in the handle and coupled to generate electronic images of an inside of the mouth;

processing circuitry, which is coupled to receive and process the electronic images so as to provide an output image for viewing by a user of the device; and

an electrical control, which is located on the handle and is operable by the user to cause the processing circuitry to freeze the output image after a predetermined delay greater than 0.5 sec following actuation of the control by the user.

In a disclosed embodiment, the processing circuitry is operative to provide an audible indication to the user after the user has operated the control and just before freezing the output image.

There is additionally provided, in accordance with an embodiment of the present invention, an intraoral viewing device, including:

a handle;

an image sensor, contained in the handle and coupled to generate electronic images of an inside of the mouth;

processing circuitry, which is coupled to receive and process the electronic images so as to provide an output image for viewing by a user of-the device; and

an electrical control, which is located on the handle and is operable by the user to cause the processing circuitry to apply to the output image at least one transformation selected from a group of transformations consisting of rotating the image and performing a right-left inversion of the image.

In a disclosed embodiment, the device includes a mirror, connected to a distal end of the handle, for providing an optical image of the inside of the mouth, and the processing circuitry is configured both to rotate and image and to perform the right-left inversion of the image simultaneously.

There is further provided, in accordance with an embodiment of the present invention, a method for intraoral visualization, including:

providing an intraoral viewing device including a handle, a mirror mount connected to a distal end of the handle, and an image sensor, contained in the handle;

fitting a flexible sheath over the device so as to cover the mirror mount and the handle;

fastening a mirror to the mirror mount over the sheath, with the sheath intervening between the mirror and the mirror mount; and

inserting at least the mirror mount, covered by the sheath, with the mirror fastened thereto, into a mouth of the subject, so that the mirror provides optical images of an inside of the mouth, and the image sensor provides electronic images of the inside of the mouth.

In some embodiments, the method includes providing one or more electrical controls on the handle, for operation by a user of the device by applying pressure to the controls through the sheath. Typically, providing the one or more electrical controls includes applying to the electronic images, responsively to actuation of at least one of the electrical controls, at least one transformation selected from a group of transformations consisting of rotating the images, performing a right-left inversion of the images, and freezing one of the images. Additionally or alternatively, the method includes illuminating the inside of the mouth using a light source associated with the intraoral viewing device, and providing the one or more electrical controls includes controlling an intensity of the light source responsively to actuation of at least one of the electrical controls.

The present invention will be more fully understood from the following detailed description of the embodiments thereof, taken together with the drawings in which:

### BRIEF DESCRIPTION OF THE DRAWINGS

FIG. 1 is a schematic, frontal view of an intraoral viewing device, in accordance with an embodiment of the present invention;

FIG. 2 is a schematic, frontal view of a mirror for use as part of an intraoral viewing device, in accordance with an embodiment of the present invention;

FIG. 3 is a schematic, sectional illustration of the intraoral viewing device of FIG. 1, taken along line III-III in FIG. 1;

FIG. 4 is a schematic, frontal view of a sheath, which fits over an intraoral viewing device, in accordance with an embodiment of the present invention;

FIG. 5 is a schematic, sectional view showing assembly of a sheath, mirror and plug on an intraoral viewing device, in accordance with an embodiment of the present invention;

FIG. 6 is a schematic, sectional view showing the intraoral viewing device of FIG. 5 in a working configuration, in accordance with an embodiment of the present invention; and

FIGS. 7A and 7B are flow charts that schematically illustrate methods for controlling image processing functions of an intraoral viewing device, in accordance with embodiments of the present invention.

### DETAILED DESCRIPTION OF EMBODIMENTS

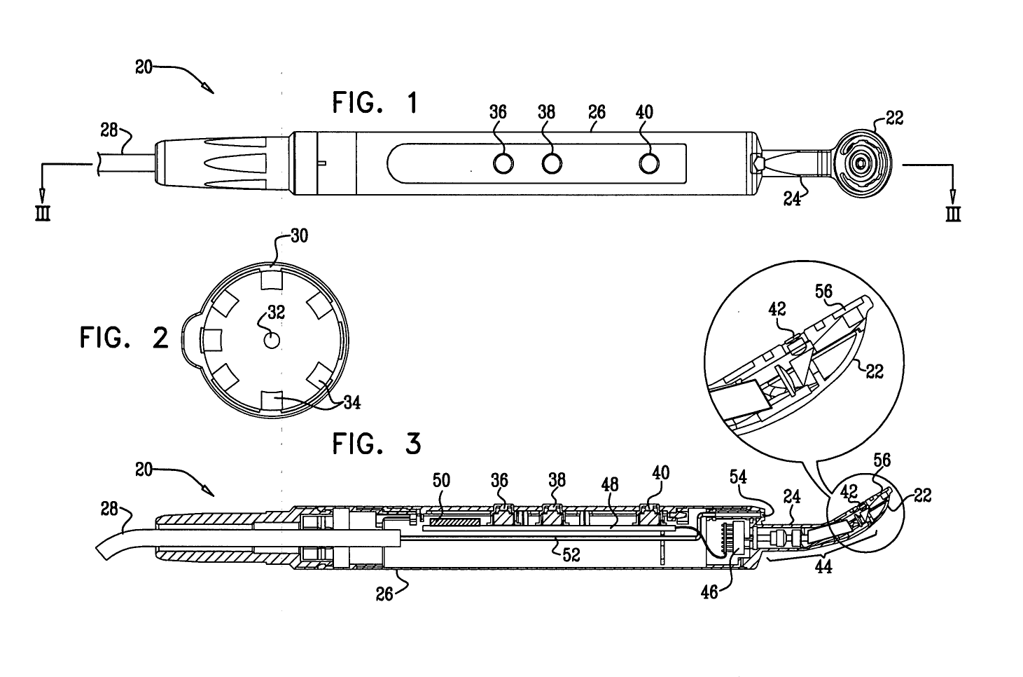

Reference is now made to FIGS. 1-3, which schematically show elements of an intraoral viewing device 20, in accordance with an embodiment of the present invention. FIG. 1 is a frontal view of the device, while FIG. 3 is a sectional view of the device taken along line III-III in FIG. 1. FIG. 2 is a frontal view of a disposable mirror 30 that is used as part of device 20.

Device 20 combines the functions of a dental mirror and an intraoral camera, and thus provides the user (typically a dentist) with optical and electronic images of the inside of the mouth of a subject. The overall design of device 20 is similar to that of the device described in the above-mentioned U.S. Pat. No. 6,276,934. Device 20, however, has a number of novel features, as described in detail hereinbelow, that enhance its ease of use, versatility and sterility. Although these features are all described herein with reference to the specific design of device 20, some or all of the features may similarly be applied, mutatis mutandis, individually or in combination, to intraoral viewing device of other types and designs. Specifically, at least some of the features may be applied to intraoral cameras that do not include the dental mirror function of device 20.

Device 20 comprises a mirror holder 22, which is attached by a shank 24 to the distal end of a handle 26. A cable 28, containing electrical wires and a fluid channel, connects device 20 to a control unit and video console (not shown in the figures). Disposable mirror 30, shown in FIG. 2, is shaped to snap onto mirror holder 22. Thus, when mirror 30 is assembled on holder 22, device 20 has the general shape of a conventional dental mirror, and may be used by a dentist in the subject's mouth for direct viewing of the teeth and gums, as well for other purposes, such as retraction of tissues. Mirror 30 has a central transparent aperture 32, which serves as a viewing aperture for an objective lens 42 of a video imaging assembly inside handle 26, as described below. Peripheral transparent apertures 34 around the edge of the mirror allow illumination to pass from light sources 56 in mirror holder 22 onto the viewing area in the subject's mouth.

An optical assembly 44 contained in mirror holder 22 and shank 24 turns and focuses light gathered by objective lens 42 so as to form an image of the inside of the subject's mouth on the focal plane of an image sensor 46 in handle 26. In the arrangement of optics shown in the figure, the image formed on the sensor will be roughly congruent with the image viewed directly by the dentist using mirror 30. Sensor 46 may comprise any suitable type of solid-state image sensor known in the art, such as a CCD or CMOS detector array. The sensor is connected to a circuit board 48 in handle 26, which provides electrical power to the sensor and receives electronic image signals that are generated by the sensor. A processing circuit 50 processes the sensor signals in order to produce output images for display on the video console. Certain novel image processing functions of circuit 50 are described hereinbelow. Alternatively, some or all of the functions of circuit 50 may be performed by circuitry in the control unit, external to device 20.

A lumen 52 in handle 26 is coupled to convey a pressurized fluid from the console via a channel (not shown) in cable 28 to an outlet 54. The outlet is located and configured to direct the fluid toward mirror 30, in order to clean the mirror surface while it is in use in the subject's mouth. Any suitable fluid, including either a gas or a liquid, may be conveyed through the lumen. Typically, compressed air may be used for this purpose.

One or more electrical controls 36, 38, 40 are located on handle 26, in locations at which they may conveniently be actuated by a user of device 20. Typically, these controls comprise sealed, pressure-sensitive buttons, which are approximately flush with the outer surface of the handle and connect to the circuitry on circuit board 48. One of these buttons may be used, for example, to control the flow of pressurized fluid through lumen 52, so that mirror 30 can be cleaned when desired. Another button could be used to control the intensity of light sources 56. Other buttons may be used to control image processing functions of circuit 50 (or equivalent functions performed in the control unit), as described hereinbelow.

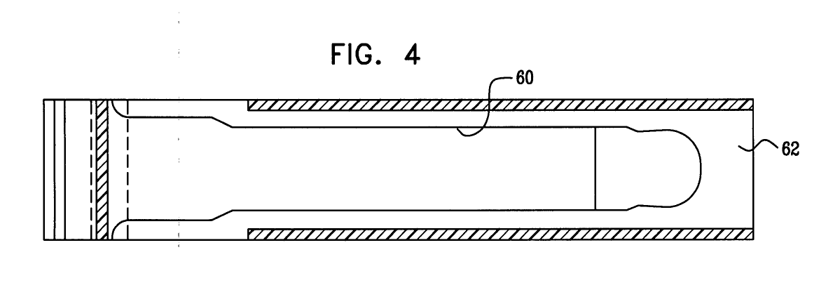

Reference is now made to FIGS. 4-6, which schematically illustrate the use of a sheath 60 in maintaining the sterility of device 20, in accordance with an embodiment of the present invention. FIG. 4 is a frontal view of the sheath as it is supplied to the user, before it is assembled onto the device. Typically, sheath 60 comprises a flexible, transparent, biocompatible plastic, such as ethylene methyl acrylate copolymer (EMAC) or low-density polyethylene. The sheath may be furnished on a stiffer backing 62 in order to protect it from damage and to ease its assembly onto device 20 without compromising sterility. The proximal end of sheath 60 (at the left in the figures) is open, while the distal end (at the right) is sealed.

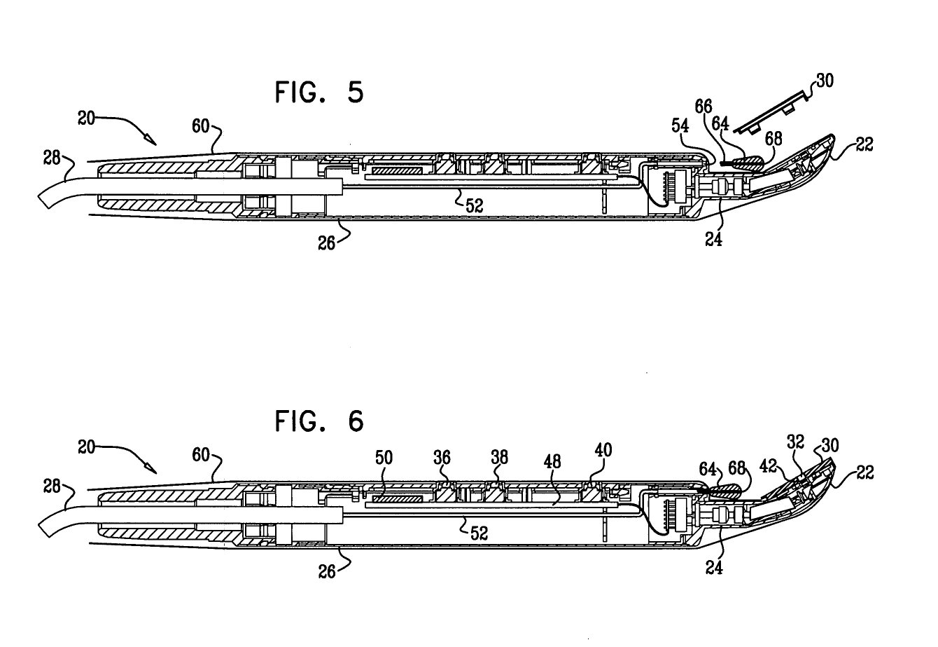

As shown in FIG. 5, device 20 is inserted into the proximal end of sheath 60 and is advanced so that mirror holder 22 engages the distal end of the sheath. The sheath thus covers the entire length of device 20, and may also cover at least a portion of cable 28. Consequently, the device is protected from contact with tissues and fluids inside the subject's mouth. Disposal of the sheath after use is sufficient to ensure that there is be no cross-contamination between subjects and to obviate any need to clean (let alone sterilize) device 20 between uses.

Mirror 30 fastens onto mirror holder 22, typically by a snap fit, over sheath 60, so that the sheath intervenes between the mirror and mirror holder, as shown in FIG. 6. As noted above, the mirror is disposed of after use, since it comes in contact with the subject's mouth. When the mirror is assembled on mirror holder 22, aperture 32 is aligned with objective lens 42, and sheath 60 is held flat between the rear surface of the mirror and the front surface of the mirror holder. Because the sheath is thin, transparent and held flat, it has substantially no effect on the image formed by optical assembly 44.

Sheath 60 also covers outlet 54 of lumen 52. In order to permit fluid to exit the lumen, a plug 64 is used to puncture the sheath at outlet 54, as shown in FIGS. 5 and 6. The plug has a hollow needle 66 at its proximal end, which is designed to puncture sheath 60 and then fit snugly inside outlet 54 of lumen 52. In this configuration, a channel 68 passing through plug 64 communicates with the lumen and directs the pressurized fluid from the lumen toward mirror 30. After use, plug 64 is removed and disposed of, along with the disposable mirror and sheath. Positive pressure may be maintained in lumen 52 during use to prevent cross-contamination due to backflow of fluids from the subject's mouth.

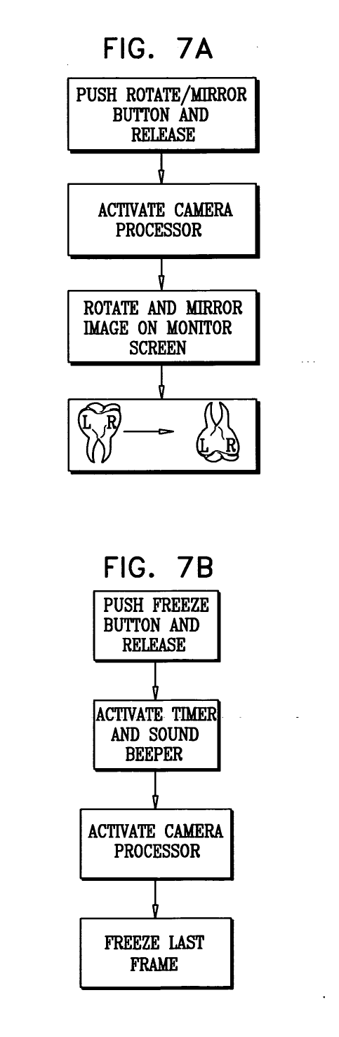

FIGS. 7A and 7B are flow charts that schematically illustrate methods for controlling image processing functions of circuit 50, in accordance with embodiments of the present invention. As noted above, one or more of controls 36, 38, 40 may be used to control such functions. These functions, may include, for example:
Image rotation and right-left inversion. These operations are useful in assisting the user in visually correlating the output image viewed on a video console with the optical image seen in the mirror. In particular, right-left inversion may be used to flip the electronic images generated by sensor 46 to accord with the mirror-image view seen in mirror 30. Image rotation, typically by 180°, is useful in maintaining visual correlation between the video output image and the optical mirror image when the user rotates device 20 to switch between viewing the lower and upper teeth, and vice versa. Device 20 may be configured to perform either image rotation or inversion individually or to perform both operations together, as shown in FIG. 7A.
Freeze frame. In intraoral cameras that are known in the art, the output image is generally frozen immediately (i.e., with a delay no greater than a few video frames, on the order of no more than a tenth of a second) when the user presses the freeze frame button. On device 20, however, when the user presses one of controls 36, 38, 40, it may cause a small sideways movement of the device. An immediate freeze-frame image might therefore be blurred. To avoid this problem, the freeze frame is delayed by at least 0.5 sec after the user presses the appropriate control, as illustrated in FIG. 7B. The inventors have found that a delay of about 3 sec gives good results, although the optimal delay may vary among different users and different applications. This delay gives the user an opportunity to stabilize the device before the freeze-frame image is captured. Optionally, device 20 may sound an audible indication, such as a brief tone, just before the freeze-frame image is to be captured, in order to remind the user to hold the device still. The delay in capturing the freeze-frame image is not desirable in most imaging applications, but poses no significant disadvantage in intraoral imaging since the structures under view in the mouth are stationary anyway.

### As noted above, these image processing functions may be used with device 20 or with intraoral cameras of other types, whether or not the camera includes a dental mirror, as well.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An intraoral viewing device, comprising:
a handle having a distal end;
a mirror mount, connected to the distal end of the handle, for insertion into a mouth of a patient;
an image sensor, contained in the handle and coupled to provide electronic images of the inside of the mouth;
a flexible sheath, which fits over and covers the mirror mount and the handle; and
a mirror, which is configured to be fastened to the mirror mount over the sheath, with the sheath intervening between the mirror and the mirror mount, so as to provide optical images of the inside of the mouth.

2. The device according to claim 1, wherein the handle contains a lumen, which is configured to direct a pressurized fluid toward the mirror through a puncture in the sheath.

3. The device according to claim 2, wherein the lumen has an outlet, and comprising a plug, which is configured to puncture the sheath and to be received within the outlet of the lumen, the plug having a channel therethrough for conveying the pressurized fluid from the lumen to the mirror.

4. The device according to claim 1, and comprising one or more electrical controls located on the handle, which are operable by a user of the device by applying pressure to the controls through the sheath.

5. The device according to claim 4, wherein the electrical controls are operable by the user to cause processing circuitry to apply to the electronic images at least one transformation selected from a group of transformations consisting of rotating the images, performing a right-left inversion of the images, and freezing one of the images.

6. The device according to claim 1, and comprising an optical assembly, which is configured to image the inside of the mouth onto the image sensor via an aperture in the device, and wherein the sheath covers a transparent material, which covers the aperture.

7. The device according to claim 6, wherein at least a part of the optical assembly is located in the mirror mount, and wherein the aperture is located in the mirror.

8. An intraoral viewing device, comprising:
a handle;
an image sensor, contained in the handle and coupled to generate electronic images of an inside of the mouth;
processing circuitry, which is coupled to receive and process the electronic images so as to provide an output image for viewing by a user of the device; and
an electrical control, which is located on the handle and is operable by the user to cause the processing circuitry to freeze the output image after a predetermined delay greater than 0.5 sec following actuation of the control by the user.

9. The device according to claim 8, wherein the processing circuitry is operative to provide an audible indication to the user after the user has operated the control and just before freezing the output image.

10. An intraoral viewing device, comprising:
a handle;
an image sensor, contained in the handle and coupled to generate electronic images of an inside of the mouth;
processing circuitry, which is coupled to receive and process the electronic images so as to provide an output image for viewing by a user of the device; and
an electrical control, which is located on the handle and is operable by the user to cause the processing circuitry to apply to the output image at least one transformation selected from a group of transformations consisting of rotating the image and performing a right-left inversion of the image.

11. The device according to claim 10, and comprising a mirror, connected to a distal end of the handle, for providing an optical image of the inside of the mouth.

12. The device according to claim 10, wherein the processing circuitry is configured both to rotate and image and to perform the right-left inversion of the image simultaneously.

13. A method for intraoral visualization, comprising:
providing an intraoral viewing device comprising a handle, a mirror mount connected to a distal end of the handle, and an image sensor, contained in the handle;
fitting a flexible sheath over the device so as to cover the mirror mount and the handle;
fastening a mirror to the mirror mount over the sheath, with the sheath intervening between the mirror and the mirror mount; and
inserting at least the mirror mount, covered by the sheath, with the mirror fastened thereto, into a mouth of the subject, so that the mirror provides optical images of an inside of the mouth, and the image sensor provides electronic images of the inside of the mouth.

14. The method according to claim 13, wherein the handle contains a lumen, and comprising creating a puncture in the sheath, and directing a pressurized fluid toward the mirror via the lumen through the puncture.

15. The method according to claim 14, wherein the lumen has an outlet, and wherein creating the puncture comprises puncturing the sheath by inserting a plug into the outlet of the lumen, the plug having a channel therethrough for conveying the pressurized fluid from the lumen to the mirror.

16. The method according to claim 13, and comprising providing one or more electrical controls on the handle, for operation by a user of the device by applying pressure to the controls through the sheath.

17. The method according to claim 16, wherein providing the one or more electrical controls comprises applying to the electronic images, responsively to actuation of at least one of the electrical controls, at least one transformation selected from a group of transformations consisting of rotating the images, performing a right-left inversion of the images, and freezing one of the images.

18. The method according to claim 16, and comprising illuminating the inside of the mouth using a light source associated with the intraoral viewing device, and wherein providing the one or more electrical controls comprises controlling an intensity of the light source responsively to actuation of at least one of the electrical controls.

19. The method according to claim 13, wherein inserting at least the mirror mount comprises imaging the inside of the mouth onto the image sensor via an aperture in the device, and wherein the sheath covers a transparent material, which covers the aperture.

20. The method according to claim 19, wherein at least a part of the optical assembly is located in the mirror mount, and wherein the aperture is located in the mirror.
